(19) United States
(12) Patent Application Publication
(10) Pub. No.: US 2014/0018205 A1
(43) Pub. Date: Jan. 16, 2014

(54) DRIVE FORCE DISTRIBUTING APPARATUS

(71) Applicant: NISSAN MOTOR CO., LTD., Yokohama-shi (JP)

(72) Inventors: Tetsu TAKAISHI, Chigasaki-shi (JP); Atsuhiro MORI, Fujisawa-shi (JP); Shunichi MITSUISHI, Isehara-shi (JP); Eigo SAKAGAMI, Kawasaki-shi (JP); Katsuyoshi OGAWA, Yokohama-shi (JP)

(21) Appl. No.: 13/928,783

(22) Filed: Jun. 27, 2013

(30) Foreign Application Priority Data
Jul. 12, 2012 (JP) 2012-156116

(51) Int. Cl. F16H 13/04

(52) U.S. Cl. CPC F16H 13/04
USPC 476/68

(57) ABSTRACT

A drive force distributing apparatus includes a first roller that is rotatable with a main drive wheel system and a second roller that is rotatable with a subordinate drive wheel system. Control of the drive force distribution between the main drive wheel system and the subordinate drive wheel system is carried out by turning the second roller by the rotation of a crankshaft to thereby adjust a radial pressing force of the second roller against the first roller. A bearing support includes an exterior wall disposed in a housing, a first through bore formed in the exterior wall for receiving a shaft portion of the first roller, a first interior side wall extending radially outward from the first through bore, a second through bore formed in the exterior wall for receiving a crankshaft, and a second interior side wall extending radially outward from the second through bore. An angle formed between a rotational axis of the first roller and a rotational axis of the second roller is a first angle, an angle formed between the first interior side wall and the exterior wall is a predetermined angle larger than “0”, and an angle formed between the second interior side wall and the exterior wall is an angle obtained by subtracting the predetermined angle from the first angle.

### CROSS-REFERENCE TO RELATED APPLICATIONS

This application claims priority under 35 U.S.C. §119 to Japanese Patent Application No. 2012-156116 filed Jul. 12, 2012. The entire disclosure of Japanese Patent Application No. 2012-156116 is incorporated herein by reference.

### BACKGROUND OF THE INVENTION

### Field of the Invention

The present invention generally relates to a vehicle drive force distributing apparatus. More particularly, the present invention relates to a frictional transmission type vehicle drive force distributing apparatus.

In Japanese Laid-open Patent Publication No. 2012-11794 (and corresponding U.S. Patent Application Publication No. 2011/0319223 A), an example of conventional frictional transmission type drive force distributing apparatus is disclosed. The conventional drive force distributing apparatus shown is provided with a first roller mechanically coupled to a transmission system of main drive wheel and a second roller mechanically coupled to a drive system of sub-drive wheel. The apparatus operates the first roller and the second roller to make frictional contact with each other at their outer circumferential surfaces to distribute a part of a torque being transmitted to the main drive wheel to the subordinate drive wheel. Accordingly, a torque transmission capacity between the rollers can be controlled by adjusting a radial pressing force between the first roller and the second roller. The torque transmission capacity therefore controls the distribution of the drive force between the main drive wheel and the sub-drive wheel.

Such a mechanism for carrying out the drive force distributing control is proposed in the above referenced document, and, by radially displacing a second roller relative to a first roller with the shaft portion of the second roller circling by motor about a fixed shaft axis of a housing, the radial depression force between the first roller and the second roller will be adjusted to effect the control drive force distribution between the main drive wheel and subordinate or driven wheel.

More specifically, such a structure is proposed in which the outer periphery of a hollow crankshaft is disposed to be rotatable about the fixed shaft axis of the housing, and the shaft portion of the second roller is rotatably supported on an eccentric hollow bore within the hollow crank shaft so that, by causing the second roller to rotate about the fixed shaft axis by the rotation of the crankshaft about the fixed shaft axis to thereby adjusting the pressing force of the second roller exerted against the first roller, the drive force distribution control is able to be performed between the main drive wheel and sub-drive wheel.

### SUMMARY OF THE INVENTION

Since the first roller is in contact with the second roller with a slope or inclination, the input force from bearing support supporting the shaft portion of the first and second rollers to a contact surface of housing is not uniform between the first roller and the second roller so that it is difficult to ensure a stable state of assembly.

An objective of the present invention is thus set in light of the above problem and in an embodiment resides in providing a drive force distributing apparatus enabling a stable assembly condition of the housing even when the first and second rollers are in contact with a slope or inclination angle to each other.

In an embodiment, in the invention provides a drive force distributing appratus including a first roller that is rotatable jointly with a main drive wheel system and a second roller that is rotatable jointly with a subordinate drive wheel system in which a drive force distribution to the subordinate drive wheel system is enabled by contacting the first roller and the second roller between the respective outer peripheral surfaces of the first roller and the second roller, wherein a shaft portion of the second roller is rotatably supported in an eccentric bore of a crankshaft that in turn is rotatable about a fixed shaft axis of a housing, and control of the drive force distribution between the main drive wheel system and the subordinate drive wheel system is carried out by turning the second roller by the rotation of the crankshaft about the fixed shaft axis to thereby adjust a radial pressing force of the second roller against the first roller. A bearing support includes an exterior wall disposed in a housing, a first through bore formed in the exterior wall for receiving a shaft portion of the first roller, a first interior side wall extending radially outward from the first through bore, a second through bore formed in the exterior wall for receiving a crankshaft, and a second interior side wall extending radially outward from the second through bore. An angle formed between a rotational axis of the first roller and a rotational axis of the second roller is a first angle, an angle formed between the first interior side wall and the exterior wall is a predetermined angle larger than “0”, and an angle formed between the second interior side wall and the exterior wall is an angle obtained by subtracting the predetermined angle from the first angle.

Therefore, a stable state of assembly may be achieved by suppressing the ununiform distribution of forces acting on the housing via a bearing support from the input and/or output shaft.

### BRIEF DESCRIPTION OF THE DRAWINGS

The accompanying drawings, which are incorporated herein and constitute part of this specification, illustrate the presently preferred embodiments of the invention, and together with the general description given above and the detailed description given below, serve to explain features of the invention.

FIG. 1 is a schematic top plan view of an example of a power train of a four-wheel drive vehicle equipped with a drive force distributing apparatus according to a first embodiment;

FIG. 2 is a vertical cross-sectional side view of the drive force distributing apparatus shown in FIG. 1;

FIG. 3 is a vertical cross-sectional front view of a crankshaft used in the drive force distributing apparatus;

FIGS. 4A through 4C are a series of views illustrating operation diagrams of the drive force distributing apparatus shown in FIG. 2, with FIG. 4A illustrating an operation diagram in which the first roller and the second roller are separated from each other at crankshaft rotation angle at reference position of “0” degrees, FIG. 4B illustrating an operation diagram in which the first roller and the second roller are in a contact state at 90 degrees, and FIG. 4C illustrating the contact state between the first roller and the second roller at crankshaft angle being at 180 degrees.

FIG. 5 is a schematic cross sectional view illustrating the housing and the force acting thereon in the drive force distributing apparatus in the first embodiment;

FIG. 6 is a schematic cross sectional view illustrating the housing and the force acting thereon in the drive force distributing apparatus in the reference technology.

### DETAILED DESCRIPTION OF THE PREFERRED EMBODIMENTS

Embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

### First Embodiment

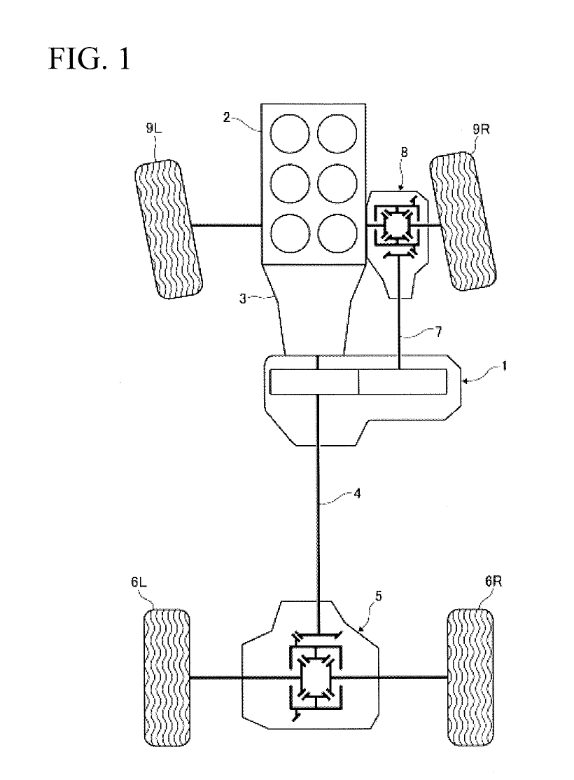

FIG. 1 is a schematic top plan view of a power train of a four-wheel drive vehicle equipped with a drive force distributing apparatus 1 according to a first embodiment. In this embodiment, the drive force distributing apparatus 1 can operate as a transfer case. The basic structure is disclosed in Applicants' own U.S. Patent Application Publication No. 2011/0319223 A, which is incorporated by reference herein.

The four-wheel drive vehicle is based on a rear wheel drive configuration in which torque from an engine 2 is multiplied by a transmission 3 and is transferred through a rear propeller shaft 4 and a rear final drive unit 5 to left and right rear wheels 6L and 6R. The vehicle can operate in a four-wheel drive manner by using the drive force distributing apparatus 1 to divert a portion of the torque being provided to the left and right rear wheels (main drive wheels) 6L and 6R through a front propeller shaft 7 and a front final drive unit 8 to transmit torque to left and right front wheels (subordinate drive wheels) 9L and 9R.

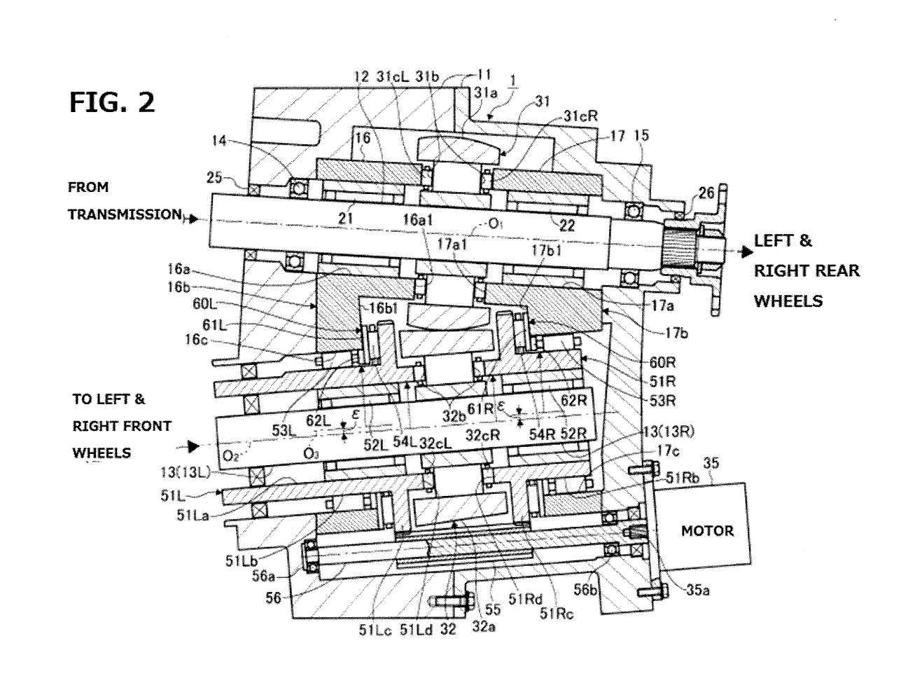

The drive force distributing apparatus 1 thus determines a drive force distribution ratio between the left and right rear wheels (main drive wheels) 6L and 6R and the left and right front wheels (subordinate drive wheels) 9L and 9R. In this embodiment, the drive force distributing apparatus 1 can be configured as shown in FIG. 2.

That is, as shown in FIG. 2, the apparatus includes a housing 11. An input shaft 12 and an output shaft 13 are arranged to span across an inside of the housing 11 diagonally with respect to each other such that a rotational axis O₁ of the input shaft 12 and a rotational axis O₂ of the output shaft 13 intersect each other. The input shaft 12 is rotatably supported in the housing 11 on ball bearings 14 and 15 located at both ends of the input shaft 12. Furthermore, both ends of the input shaft 12 protrude from the housing 11 and are sealed in a liquid-tight fashion or a substantially liquid-tight fashion by seal rings 25 and 26. In this arrangement, one end of the input shaft 12 shown at the left side of FIG. 2 is coupled to an output shaft of the transmission 3 (see FIG. 1). Also, the other end of the input shaft 2 at the right side of FIG. 2 is coupled to the rear final drive unit 5 through the rear propeller shaft 4 (see FIG. 1)

In addition, a pair of bearing supports 16 and 17 are provided between the input shaft 12 and the output shaft 13 in positions near the ends of the input shaft 12 and the output shaft 13. The bearing supports 16 and 17 are fastened to axially opposite internal walls of the housing 11 with fastening bolts (not shown), at approximate middle portions of the bearing supports 16 and 17. Note that the installation of the bearing supports 16, 17 to housing 11 as well as their positional relationship with respect to input/output shafts 12, 13 are described below. Bearing support 16, 17 is provided with an input shaft through bore 16a, 17a, output shaft through bore 16c, 17c for passing through the output shaft 13 and crankshaft 51L, 51R, and a vertical wall 16b, 17b connecting between the input shaft through bore 16a, 17a and output shaft through bore 16c, 17c, and is generally shaped in the axial direction front view. Roller bearings 21, 22 are arranged between the bearing supports 16, 17 and input shaft 12 for supporting the input shaft 12 freely or rotatably relative to bearing supports 16, 17 so that input shaft 12 is supported inside the housing 11 rotatably through the bearing supports 16, 17 as well.

A first roller 31 is formed integrally and coaxially with the input shaft 12 in an axially intermediate position located between the bearing supports 16 and 17, that is, between the roller bearings 21 and 22. A second roller 32 is formed integrally and coaxially with the output shaft 13 in an axially intermediate position such that the second roller 32 can make frictional contact with the first roller 31. Naturally, the first roller 31 can instead be attached to the input shaft 12 in any suitable manner instead of being integral with the input shaft 12. Likewise, the second roller 32 can instead be attached to the output shaft 13 in any suitable manner instead of being integral with the input shaft 12. The outer circumferential surfaces of the first roller 31 and the second roller 32 are conically tapered in accordance with the diagonal relationship of the input shaft 12 and the output shaft 13 such that the outer circumferential surfaces can contact each other without or substantially without a gap between the surfaces. At both sides of radial extension of the first roller 31 and the second roller 32 are formed with retention grooves 31b, 32b to contact with and retain radially thrust bearings 31c1, 31cR, 32c1. 32cR. The thrust bearings 31cL, 31cR position first roller 31 by contacting the first side walls 16a1, 17a1 of bearing supports 16, 17. On the other hand, the thrust bearings 32cL, 32cR position second roller 32 by contacting the roller side contact portions 51Ld, 51Rd of crankshaft 51L, 51R described below.

The output shaft 13 is rotatably supported with respect to the bearings supports 16 and 17 at positions near both ends of the output shaft 13. Thus, the output shaft 13 is rotatably supported inside the housing 11 through the bearing supports 16 and 17. A support structure used to support the output shaft 13 rotatably with respect to the bearing supports 16 and 17 is realized by an eccentric support structure as will now be explained.

As shown in FIG. 2, a crankshaft 51L configured as a hollow outer shaft is moveably fitted between the output shaft 13 and the bearing support 16. Also, a crankshaft 51 R configured as a hollow outer shaft is moveably fitted between the output shaft 13 and the bearing support 17. The crankshaft 51L and the output shaft 13 protrude from the housing 11 as shown on the left side of FIG. 2. At the protruding portion, a seal ring 27 is installed between the housing 11 and the crankshaft 51L. Also, a seal ring 28 is installed between the crankshaft 51L and the output shaft 13. The seal rings 27 and 28 serve to seal the portions where the crankshaft 51 L and the output shaft 13 protrude from the housing 11 in a liquid-tight or substantially liquid-tight fashion.

The left end of the output shaft 13 protruding from the housing 11 in FIG. 2 is coupled to the front wheels 9L and 9R through the front propeller shaft 7 (see FIG. 1) and the front final drive unit 8.

A roller bearing 52L is arranged between a center hole 51La (radius Ri) of the crankshaft 51 L and a corresponding end portion of the output shaft 13. Also, a roller bearing 52R is arranged between a center hole 51 Ra (radius Ri) of the crankshaft 51 R and a corresponding end portion of the output shaft 13. Thus, the output shaft 13 is supported such that the output shaft 13 can rotate freely about the center axis O₂ inside the center holes 51 La and 51Ra of the crankshaft 51L and 51R

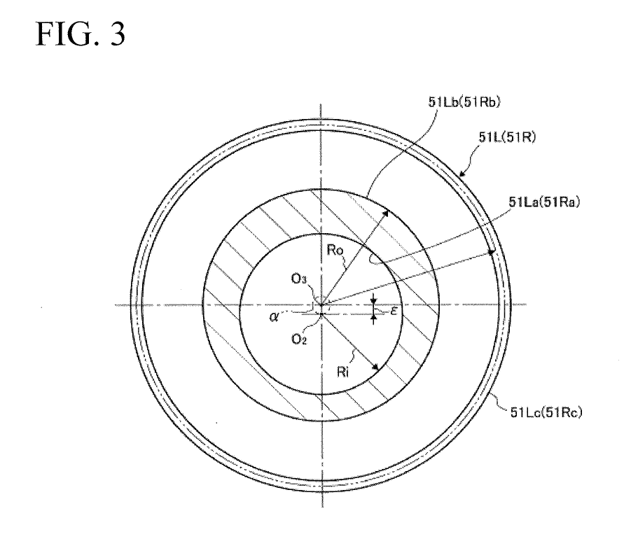

As shown clearly in FIG. 3, the crankshaft 51 L has an outer circumferential portion 51 Lb (center shaft axis O3, radius Ro) that is eccentric with respect to the center hole 51 La. Also, the crankshaft 51 R has an outer circumferential portion 51 Rb (center shaft axis 03, radius Ro) that is eccentric with respect to the center hole 51 Ra. The eccentric outer circumferential portions 51 Lb and 51 Rb are offset from the center axis (rotational axis) O₂ of the center holes 51 La and 51 Ra by an eccentric amount c. The eccentric outer circumferential portion 51Lb of the crankshaft 51 L is rotatably supported inside the corresponding bearing support 16 through a roller bearing 53L. The eccentric outer circumferential portion 51Rb of the crankshaft 51 R is rotatably supported inside the corresponding bearing support 17 through a roller bearing 53R. In addition, the roller side contact portions 51Ld, 51Rd of crankshafts 51L, 51R are freely and rotatably supported on thrust bearings 32cL, 32cR. Further, thrust bearings 54L, 54R are provided axially outside with respect to thrust bearings 32cL, 32cR. These thrust bearings 54L, 54R contact spacers 60L, 60R roratably and also contact ring gears 51Lc, 51Rc rotatably to thereby support crankshaft 51L and 51R rotatably fee.

Spacers 60L, 60 R are composed of a first spacer portions 61L, 61R which respectively contacts the second wall surface 16b1, 17b1 of the vertical wall 16b, 17b facing the second roller 32 and respectively extends radially inwardly of output shaft through bore or hole 16c, 17c up to a position of contact free of the crankshaft 51L and a second spacer portions 62L, 62R (extension portion) that respectively extends to be inserted in the output shaft bore 16c, 17c. In addition, spacers 60L, 60R are positioned radially through contact between the outer periphery of the second spacer portions 62L, 62R and the inner periphery surface of output shaft through bores 16c, 17c while mutual interference between roller bearings 53L, 53R and thrust bearing 54R, 54L are avoided.

Thus, since, by extending radially inwardly first spacer portions 61L, 61R, thrust bearing 54R, 54L are provided along the radial direction of the first spacer portions 61L, 61R, the capacity of the bearing may be increased without increase in size in the radially outward direction. Further, due to large-sized roller bearings 53L, 53R, even when the gap is increased between crankshaft 51L, 51R and the inner periphery of output shaft hole or bore 16c, 17c of bearing supports 16, 17, thrust bearings 54L, 54R may be received at a radially inner side by the first spacer portions 61L, 61R so that the size increase in the radial direction may be avoided.

In addition, since the positioning in the radial direction is performed at the outer periphery of the second spacer portions 62L, 62R, contact between spacers 60L, 60R and crankshaft 51L, 51R may be avoided and friction loss due to an increase in sliding resistance may be suppressed. Stated another way, while crankshaft 51L, 51R rotate relative to bearing supports 16, 17, spacers 60L, 60R do not rotate relative to bearing supports 16, 17. Therefore, by positioning using rotation-free members, points of contact may be reduced.

The ring gears 51 Lc and 51Rc are meshed with the crankshaft drive pinion 55 such that the eccentric outer circumferential portions 51Lb and 51Rb of the crankshafts 51 L and 51R are aligned with each other in a circumferential direction. That is, the rotational positions of the eccentric outer circumferential portions 51 Lb and 51 Rb are in phase with each other.

The pinion shaft 56 is rotatably supported with respect to the housing 11 by bearings 56a and 56b arranged at both ends of the pinion shaft 56. A right end of the pinion shaft 56 passes through the housing 11 as shown on the right-hand side of FIG. 2. An exposed end portion of the pinion shaft 56 is operably coupled to an output shaft 35a of an inter-roller radial pressing force control motor 35 through serration coupling and the like. Therefore, rotational position control can be executed with respect to the crankshafts 51L and 51R by driving the crankshafts 51 L and 51 R with the inter-roller radial pressing force control motor 35 through the pinions 55 and the ring gears 51 Lc and 51Rc. When this occurs, the output shaft 13 and the rotation axis O₂ of the second roller 32 turn about the center axis (rotational axis) O₃ so as to revolve along a circular path α indicated with a broken line in FIG. 3.

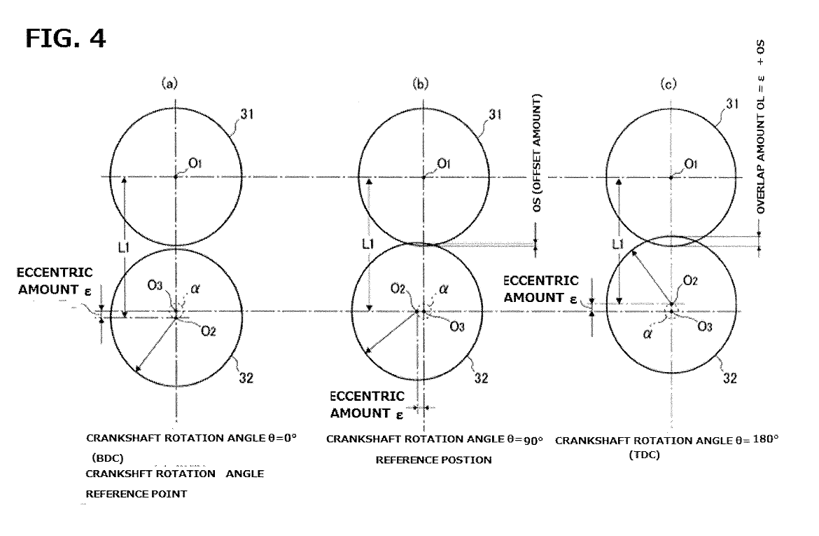

As will be described in detail later, by the turn or rotation of rotation shaft axis O2 (second roller 32) along a locus circle path α in FIG. 3, the second roller 32 approaches the first roller 31 as shown in FIGS. 4A to 4C in the radial direction. Thus, as the rotation angle θ of crankshafts 51L, 51R increases, the roller center distance L1 between the first roller 31 and the second roller 32 may be decreased to less than the sum of the radius of the first roller 31 and the radius of the second roller 32, which will cause the radial pressing force of the second roller 32 on the first roller 31 (inter-roller transmission torque capacity; traction transmission capacity) to be increased. Therefore, in response to the decrease in the inter-roller center distance L1, the inter-roller radial depressing force (inter-roller transmission torque capacity; traction transmission capacity) may be variably controlled to adjust the drive force distribution ratio freely.

Note that, as shown in FIG. 4A, in the present embodiment, the inter-roller center distance L1 in a state of bottom dead center in which the rotation shaft axis O2 is located directly below the rotation axis O3 of crankshaft and the inter-roller distance between first roller 31 and second roller 32 becomes maximum is configured to be larger than the sum of the radius of first roller 31 and the radius of the second roller 32. Thus, at the bottom dead center with crankshaft rotation angle being “0” degrees, the first roller 31 and the second roller 32 are prevented from being pressed against each other in a radial direction so that such a state may be provided in which no traction transmission between rollers 31, 32 takes place, i.e., traction transmission capacity being “0”. Therefore, traction capacity may be set arbitrarily to a value anywhere between “0” at the bottom dead center and the maximum value obtainable at the top dead center in FIG. 4C (i.e., θ=180 degrees). In the present embodiment, description is made by setting a rotation angle reference of crankshaft 51L, 51R at the bottom dead center, i.e., crankshaft rotation angle being “0”.

### Operation of Drive Force Distribution

With reference to FIGS. 1 to 4, the operation of the drive force distribution is now described. An output torque from the transmission 3 (shown in FIG. 1) is imparted to input shaft 12 of transfer case 1. The torque can be further transmitted directly from the input shaft 12 to the left and right rear wheels 6L and 6R (main drive wheels) through the rear propeller shaft 4 and the rear final drive unit 5 (both being shown in FIG. 1).

Also, when the inter-roller distance L1 (shown in FIG. 4) is set less than the sum of the radius of first roller 31 and the radius of second roller 32 in response to the rotation position control of crankshafts 51L, 51R by motor 35 through pinion 55 and ring gears 51Lc, 51Rc, the transfer case 1 acquires an inter-roller transmission torque capacity in accordance with the radial pressing force between first roller 31 and second roller 32. Depending on this torque capacity, transfer case 1 can divert a portion of the torque from the left and right rear wheels 6L and 6R (main drive wheels) toward the output shaft 13 by passing torque from the first roller 31 to the second roller 32. A torque reaching the output shaft 13 is transmitted to drive the left and right front wheels (subordinate drive wheels) 9L and 9R. Therefore, the vehicle can be operated in a four-wheel drive mode in which the left and right rear wheels 6L and 6R (main drive wheels) and the left and right front wheels (subordinate drive wheels) 9L and 9R are driven.

Note that, during torque transmission, a reaction force of the radial pressing force between first roller 31 and second roller 32 are received by bearing supports 16, 17 without reaching housing or case 11. Further, the reaction force of the radial pressing force remains “0” when the crankshaft rotation angle is within a range between 0 and 90 degree, increases in accordance with increase in crankshaft rotation angle θ between 90 and 180 degrees, and will assume the maximum value at the crankshaft rotation angle θ being 180 degrees.

During travel in the four-wheel drive mode, when the rotation angle θ of crankshaft 51L, 51R is set at a reference position of 90 degrees, the first roller 31 and second roller 32 are pressed against each other for frictional contact at a radial pressing force corresponding to an offset amount OS at this time, torque transmission takes place to left and right front wheels (subordinate drive wheels) 9L, 9R in accordance with the offset value OS between the two rollers.

As the rotation angle θ of crankshaft 51L, 51R increases from the reference position shown in FIG. 4B toward the top dead center with crankshaft rotation angle θ being at 180 degrees as shown in FIG. 4C, the inter-roller center distance L1 further decreases to increase the overlap amount OL between first roller 31 and second roller 32. Consequently, the radial pressing force between first roller 31 and second roller 32 will be increased to thereby increase the traction transmission capacity between these rollers.

When crankshafts 51L, 51R have reached the position of top dead center shown in FIG. 4C, first roller 31 and second roller 32 are pressed at the maximum radial pressing force corresponding to the maximum overlap amount OL so that the traction transmission capacity between the two will be made maximum. Note that the maximum overlap amount OL is obtained by adding the eccentric amount ε between the second roller rotation axis O2 and crankshaft rotation axis O3 to the offset amount OS described with reference to FIG. 4B.

As will be appreciated from the description above, by operating crankshafts 51L, 51R to rotate from the position of “0” crankshaft rotation angle to the position of “180” crankshaft rotation angle, an inter-roller traction transmission capacity may be varied continuously from “0” to maximum. Conversely, by operating crankshafts 51L, 51R to rotate from the position of “180” crankshaft rotation angle to the position of “0” crankshaft rotation angle, the inter-roller traction transmission capacity may be varied continuously from maximum to “0”. Thus, the inter-roller traction transmission capacity may be controlled freely by the rotational operation of crankshafts 51L, 51R.

### Relationship Among Inclination of Input/Output Shafts, Bearing Support, and Housing

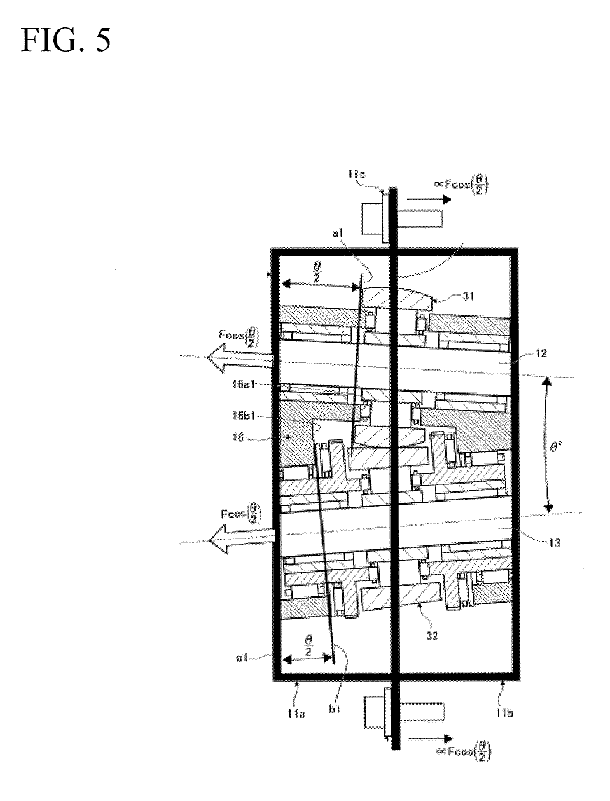

Now, the relationship among the inclination or angle formed by input and output shafts 12, 13, bearing support 16, and housing 11 will be described. FIG. 5 is a schematic cross sectional view illustrating the housing and the force exerting thereon in the drive force distributing apparatus in the first embodiment. In the drive force distributing apparatus in the first embodiment, input shaft 12 and output shaft 13 are laterally disposed or bridged within the housing 11 to be inclined with respect to each other so that respective rotation axis O1 and O2 cross. The angle formed by this inclination is defined as a first angle θ. In addition, the plane formed by the first side wall 16a1 of the side surface of bearing support 16 on the side of first roller 31 is denoted a first plane or planar surface al. Further, the plane formed by side wall 16b1 representing a side surface of bearing support 16 on the side of second roller 32 is defined as a second plane or planar surface b1. Furthermore, the place on which bearing support 16 is mounted to housing 11 is defined as a third plane or planar surface c1.

Further, housing 11 is comprised of a first housing 11a that supports bearing support 16 and a second housing 11b that is mounted to the open end of first housing 11a by bolt fastening to cover the open end. The housing mating surface of the first housing 11a and second housing 11b is defined as a fourth plane d1. At this time, the bolt fastening portion is provided on the entire circumference of the housing mating surfaces so as to ensure the stable assembled state of the housing 11 by applying a tightening force of the bolts evenly. Here, a first tightening portion 11c is defined at which input shaft 12 is located, i.e, top in FIG. 5, while a second tightening portion 11d is defined at the bolt tightening portion in which output shaft 13 is located.

Now, the operational effects of the first embodiment is described comparing to a reference technology. In the drive force transmission device 11 in the first embodiment, since the first roller 31 associated with input shaft 12 is in contact with the second roller 32 associated with output shaft 13 with an inclination or angle, a thrust force will generate during transmission of driving torque. Description is now made of the effects of the thrust force on the housing and the like.

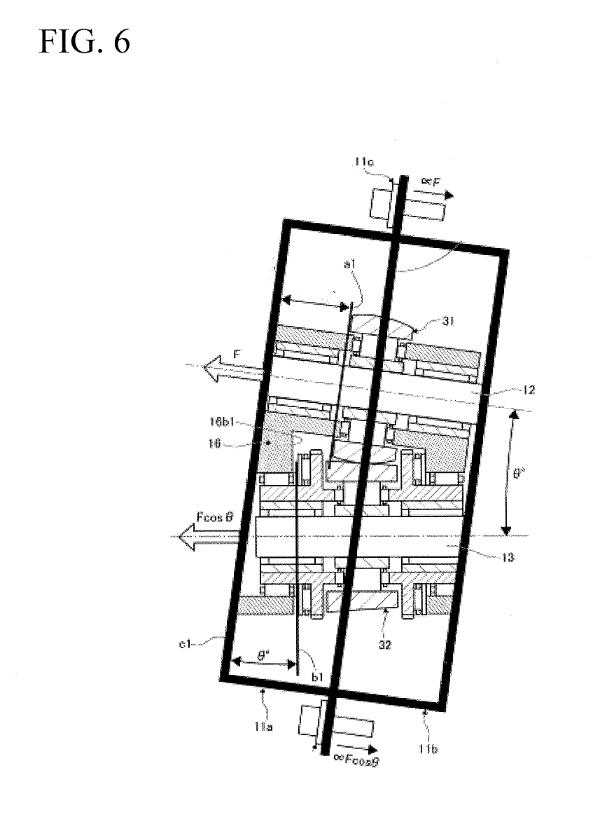

FIG. 6 is a schematic cross sectional view of the reference technology. Although some basic structure is the same as the first embodiment, the reference technology is different in that the first plane al is parallel to the third plane and the second plane b1 forms an angle of θ with the third plane c1. In the reference technology, when the thrust force exerted on input shaft 12 and output shaft 13 is denoted F, the thrust force imparted to the first plane a1 is transmitted without modification for abutment with the third plane c1 representing the housing contact surface. Thus, the force exerted from bear support 16 to housing 11a is F. On the other hand, the thrust force F input to the second plane b1 will be applied to the third plane cl representing a housing contact surface with an angle of θ. Therefore, the force applied from bearing support 16 to housing 11a assumes Fcos θ.

In other words, with respect to housing 11, force F is exerted on the housing contact surface adjacent to input shaft 12 while force Fcos θ is applicable to the housing contact surface adjacent to output shaft 13 so that the distribution of force input to housing 11 becomes ununiform which makes it difficult to achieve a stable assembly state. Further, the force exerted upon the first fastening portion 11c is in proportion to the thrust force F while the force exterted upon the second fastening portion is in proportion to the thrust force Fcos θ, which would lead to unbalanced fastening force distribution across the housing mating surface so that it may be difficult to ensure a stable assembly state.

In contrast, in the first embodiment, as shown in the schematic cross-sectional view of FIG. 5, when the angle formed between the input shaft 12 and output shaft 13 is θ, first plane a1 and the third plane c1 form an angle of θ/2, and the second plane b1 and the third plane c1 also form an angle of θ/2. Further, compared to the thrust force generating in input shaft 12 and output shaft 13, since the thrust force input to the first plane a1 is in abutment with the third plane c1 representing the housing contact surface with an angle of θ/2, the force exerted on housing 11a from bearing support 16 may be expressed by F·cos (θ/2). Similarly, since the thrust force F input on the second plane b1 is in abutment with third plane c1 representing the housing contact surface with an angle of angle (θ/2), the force exerted on the housing 11a from bearing support 16 is also expressed by F·cos (θ/2). Therefore, the force to be input from input/output shafts 12, 13 to housing 11 through bearing support 16 amount to the same value so that a stable state of assembly may be achieved due to uniformed distribution of force acting on housing 11a.

In addition, the force exerted on both the first fastening portion 11c and the second fastening portion 11d is in proportion to the thrust force, F·cos (θ/2). At this time, since the third plane c1 and the fourth plane d1 are arranged parallel to each other, the fastening force acting on housing mating surface may be uniformed to achieve the stable state of assembly.

As described above, the following operational effects are obtained in the first embodiment.

A drive force distributing apparatus including a first roller rotatable jointly with a main drive wheel system and a second roller rotatable jointly with a subordinate drive wheel system in which a drive force distribution to the subordinate drive wheel system is enabled by frictionally contacting the first roller and the second roller between the respective outer peripheral surfaces, wherein a shaft portion of the second roller 32 is rotatably supported in an eccentric bore of crankshaft 51L, 51R that in turn is rotatable about a fixed shaft axis of a housing 11, and control of the drive force distribution between the main drive wheels and the subordinate drive wheels is carried out by turning the second roller 32 by the rotation of the crankshaft 51L, 51R about the fixed shaft axis to thereby adjust a radial pressing force of the second roller 32 against the first roller 31. The apparatus further includes bearing supports 16, 17 having a vertical wall 16b extending radially inwardly of the housing 11, a first through bore 16a formed in the vertical wall 16b for receiving a shaft portion of the first roller 31, first side wall 16a1 formed in the outer periphery of the first through bore 16a, a second through bore 16c formed in vertical wall 16b for receiving crankshaft 51L, 51R, and a second side wall 16b1 formed in the outer periphery of the second through bore 16c, wherein the angle formed by the axis of the first roller 31 and the axis of the second roller 32 is a first angle θ, the angle formed by a first planar surface al representing the contact surface between first roller 31 and the first side wall 16a1 and a third planar surface c1 representing the contact surface between the bearing support 16 and first housing 11 a is θ/2 (a predetermined angle larger than “0”), and the angle formed by a second planer surface b1 representing the contact surface between the second roller 32 and second side wall 16b1 and the third planer surface c1 representing the contact surface between bearing support 16 and the first housing 11a is θ/2 (the angle obtainable by subtracting the predetermined angle from the first angle). Therefore, an ununiform distribution of the force acting on housing 11a through bearing support 16 from input/output shafts 12, 13 may be suppressed to achieve the stable state of the assembly.

The housing 11 is composed of a first housing 11a that supports bearing support 16 with an open end and a second housing 11b that is mounted from the open end of the first housing 11a by bolt fastening to over the open end. The mating surface between the first housing 11a and the second housing 11b extends in parallel to the contact surface between bearing support 16 and housing 11a. Therefore, a fastening force acting upon the housing mating surface may be uniform while achieving the stable state of the assembly.

In an embodiment, the predetermined angle is half the first angle, i.e., θ/2. Therefore, the distribution of force exerted on housing 11a from the input/output shaft 12, 13 through bearing support 16 may be uniform to achieve an even more stable state of the assembly. Further, the fastening force applied on the housing mating surface may be uniform.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiments, the following directional terms “forward, rearward, above, downward, vertical, horizontal, below and transverse” as well as any other similar directional terms refer to those directions of a device equipped with the present invention. Accordingly, these terms, as utilized to describe the present invention should be interpreted relative to a device equipped with the present invention. The term “detect” as used herein to describe an operation or function carried out by a component, a section, a device or the like includes a component, a section, a device or the like that does not require physical detection, but rather includes determining, measuring, modeling, predicting or computing or the like to carry out the operation or function. The term “configured” as used herein to describe a component, section or part of a device includes hardware and/or software that is constructed and/or programmed to carry out the desired function. Moreover, terms of degree such as “substantially”, “about” and “approximately” as used herein mean an amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

For example, it is desirable that both input and output shafts intersect with the third planer surface or plane by θ/2 as is the case in the first embodiment, however the invention is not limited to these configurations. When one of the shafts is configured to intersect at a predetermined angle other than a right angle with the third planer surface c1, the difference in distribution of exerting force can be made small so that a certain effect is achievable. In addition, in the first embodiment, the third planer surface c1 on the side of first roller 31 and the third planer surface c1 on the side of second roller 32 are arranged to be on the same surface in the first embodiment. The arrangement on the same surface is not necessarily required. Further, the housing mating surface is illustrated in a planer surface. However, as long as the parallel relationship with the third planer surface c1 is maintained, a stepped surface is also applicable.

Furthermore, in the first embodiment, only the structure on the side of bearing support 16 has been described. However, on the side of bearing support 17, the exerting force will be uniform in a similar manner, and, by maintaining the parallel relationship with the housing mating surface d1, the force exerting on respective contact portions and bolt fastening portions may be held uniform even in the case in which the direction of torque transmission is reversed and the direction of thrust force is thereby reversed.

What is claimed is:

1. A drive force distributing appratus including a first roller that is rotatable jointly with a main drive wheel system and a second roller that is rotatable jointly with a subordinate drive wheel system in which a drive force distribution to the subordinate drive wheel system is enabled by contacting the first roller and the second roller between the respective outer peripheral surfaces of the first roller and the second roller, wherein a shaft portion of the second roller is rotatably supported in an eccentric bore of a crankshaft that in turn is rotatable about a fixed shaft axis of a housing, and control of the drive force distribution between the main drive wheel system and the subordinate drive wheel system is carried out by turning the second roller by the rotation of the crankshaft about the fixed shaft axis to thereby adjust a radial pressing force of the second roller against the first roller, the drive force distributing appratus comprising:
a bearing support including
an exterior wall disposed in the housing;
a first through bore formed in the exterior wall for receiving a shaft portion of the first roller;
a first interior side wall extending radially outward from the first through bore;
a second through bore formed in the exterior wall for receiving a crankshaft, and
a second interior side wall extending radially outward from the second through bore, wherein
an angle formed between a rotational axis of the first roller and a rotational axis of the second roller is a first angle,
an angle formed between the first interior side wall and the exterior wall is a predetermined angle larger than “0”, and
an angle formed between the second interior side wall and the exterior wall is an angle obtained by subtracting the predetermined angle from the first angle.

2. The drive force distributing apparatus according to claim 1,
wherein the housing comprises a first housing that supports the bearing support with an open end, and a second housing that is mounted to the open end by bolt fastening to cover the open end, and
wherein mating surfaces between the first housing and the second housing are parallel to the exterior wall of the bearing support.

3. The drive force distributing apparatus according to claim 1, wherein the predetermined angle is half of the first angle.

4. The drive force distributing apparatus according to claim 2, wherein the predetermined angle is half of the first angle.

5. The drive force distributing apparatus according to claim 1, wherein the exterior wall of the bearing support comprises a first exterior wall disposed in a first plane, and a second exterior wall disposed in a second plane.

6. The drive force distributing apparatus according to claim 2, wherein the mating surfaces comprise first mating surfaces disposed in a first plane, and second mating surfaces disposed in a second plane.
